(19) United States
(12) Patent Application Publication
(10) Pub. No.: US 2024/0336511 A1
(43) Pub. Date: Oct. 10, 2024

(54) PROCESSES AND APPARATUSES FOR CONVERTING POLY- AND PERFLUOROALKYL SUBSTANCES

(71) Applicant: UOP LLC, Des Plaines, IL (US)

(72) Inventors: Erick J. Bennett, III, New Lenox, IL (US); William J. Whyman, Collinsville, OK (US); Elizabeth Jensen, Des Plaines, IL (US); Aric G. Fisher, Tulsa, OK (US); Gregory B. Kuzmanich, Arlington Heights, IL (US)

(21) Appl. No.: 18/586,779

(22) Filed: Feb. 26, 2024

Related U.S. Application Data
(60) Provisional application No. 63/494,703, filed on Apr. 6, 2023.

(51) Int. Cl. C02F 11/08; C02F 1/52; C02F 1/66; C02F 1/72; C02F 11/145; C02F 101/30; C02F 101/36; C02F 103/00; C02F 103/38; C02F 103/40

(52) U.S. Cl. CPC C02F 11/08; C02F 1/5236; C02F 1/66; C02F 1/72; C02F 11/145; C02F 2101/301; C02F 2101/306; C02F 2101/36; C02F 2103/006; C02F 2103/38; C02F 2103/40; C02F 2201/002; C02F 2209/02

(57) ABSTRACT

Processes and apparatuses converting poly- and perfluoroalkyl substances (PFAS). An oxidation reaction zone, preferably a thermal oxidizer, is used to oxidize the PFAS into fluoride species. A reaction zone having at least one reactor containing a solid reactant for neutralizing the fluoride species is provided. The solid reactant is also configured to degrade any PFAS remaining in the effluent from the oxidation zone. A cooling zone, for example, a quench zone may be between the reaction zone and the oxidation zone. The PFAS may be liquid PFAS that is injected into the thermal oxidizer.

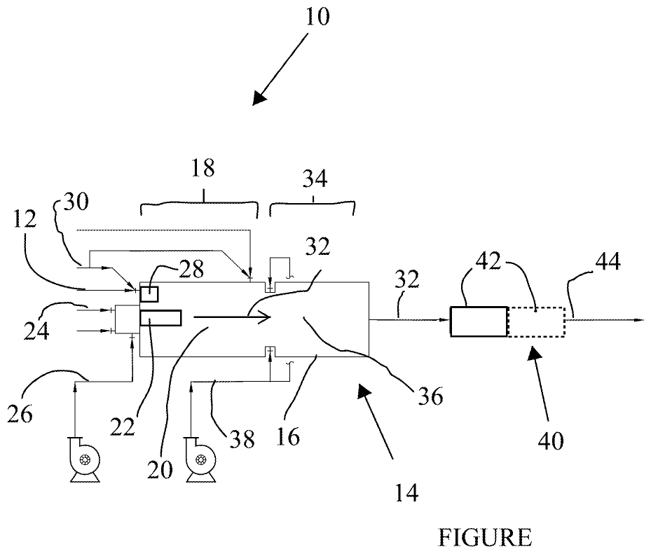

### RELATED APPLICATIONS

This application claims priority to U.S. Provisional Patent Application Ser. No. 63/494,703, filed on Apr. 6, 2023, the entirety of which is incorporated herein by reference.

### FIELD OF THE INVENTION

This invention relates generally to processes and apparatuses for removing and degrading perfluoroalkyl substances.

### BACKGROUND OF THE INVENTION

Perfluoroalkyl substances (PFAS) are “forever chemicals” that are very stable and persist in the environment. PFAS are linked to harmful effects on the kidney, liver, blood, and immune system. Examples of PFAS are surfactants in industrial and consumer products, such as firefighting foams, alkaline cleaners, paints, non-stick cookware, carpets, upholstery, shampoos, floor polishes, fume suppressants, semiconductors, photographic films, pesticide formulations, food packing, masking tape, and denture cleaners. The EPA has a list of over 179 PFAS that are toxic.

Typical PFAS concentrations are pg/L to ng/L. Currently, the EPA advises a maximum limit of <70 ppt of PFAS, however stricter EPA regulations and limits have been proposed. Accordingly, there is an ongoing need to improve remediation of PFAS.

It is known to use adsorbent materials to adsorb and remove PFAS from streams, however there is still the possibility that the adsorbed PFAS may leach into the environment from disposed adsorbent. It is also known to treat contaminated materials to degrade PFAS. While presumably effective for their intended purposes, since PFAS are limited to low amounts it is desirable to provide ways to effectively and efficiently remove and degrade PFAS.

### SUMMARY OF THE INVENTION

The present invention provides for the removal and degradation of PFAS. The PFAS may be oxidized in a thermal oxidizer and then subjected to degradation in mineralization reactor(s). The mineralization will reduce the chances of release of light fluorinated hydrocarbons or other components from the oxidation of the PFAS. Additionally, the mineralization reactor will neutralize fluoride species produced in the oxidation.

The present processes may be used with liquid PFAS, allowing streams to be injected into a thermal oxidizer, without requiring separate vaporizing equipment. Further the direct injection reduces the residence time and minimizes the size of the apparatus needed.

Therefore, the present invention may be characterized, in at least one aspect, as providing a process for converting poly- and perfluoroalkyl substances (PFAS) by: injecting a feed comprising liquid PFAS into a thermal oxidation zone; and, thermally oxidizing, in the thermal oxidation zone, the PFAS to provide a thermal oxidation effluent comprising a fluoride species.

The liquid PFAS may be injected into a thermal oxidizer in the thermal oxidation zone with one or more injection nozzles.

The process may also include atomizing the liquid PFAS before the feed is injected into a thermal oxidizer in the thermal oxidation zone with one or more injection nozzles.

The thermal oxidation zone may be configured to oxidize between 90 to 99.9999% of the PFAS in the feed stream.

The thermally oxidizing may be performed at a temperature between about 500° C. to about 2,300° C.

The process may also include cooling, in a cooling zone, the thermal oxidation effluent.

The process may further include neutralizing, in a reaction zone having a vessel containing a solid reactant, the fluoride species with the solid reactant and converting, with the solid reactant in the reaction zone, any PFAS in the thermal oxidation effluent to a fluorine salt. The solid reactant may be selected from a group consisting of: a base of calcium, sodium, potassium, lithium, magnesium, aluminum, silicon, and combinations thereof. The thermally oxidizing may be performed at a first temperature, and the neutralizing and the converting may be performed at a second temperature less than the first temperature by at least 5%.

In another aspect of the present invention, the invention may be generally characterized as providing a process for converting poly- and perfluoroalkyl substances (PFAS) by: passing a feed with liquid PFAS into a thermal oxidation zone by injecting the liquid PFAS towards a flame in the thermal oxidation zone, the thermal oxidization zone comprising a vessel; and, thermally oxidizing the PFAS to a fluoride species and producing a thermal oxidation effluent.

The liquid PFAS may be injected via one or more injection nozzles in the thermal oxidation zone.

The one or more injection nozzles may be configured to receive a liquid stream comprising the liquid PFAS.

The one or more injection nozzles may be configured to receive an atomized stream comprising the liquid PFAS.

The thermally oxidizing may be performed at a temperature between about 500° C. to about 2,300° C.

The process may also include passing the thermal oxidation effluent to a reaction zone having a vessel with a solid reactant, the solid reactant configured to neutralize the fluoride species and to convert any PFAS in the thermal oxidation effluent to a fluorine salt. The process may additionally include cooling, in a cooling zone, the thermal oxidation effluent before passing the thermal oxidation effluent to the reaction zone. The cooling zone may be a quench zone in the vessel in the thermal oxidation zone.

In a further aspect, the present invention may generally be characterized as providing an apparatus for converting poly- and perfluoroalkyl substances (PFAS) having: a thermal oxidation zone with a vessel containing one or more injected nozzles, the one or more injection nozzles configured to receive a feed with liquid PFAS and inject the liquid PFAS toward a flame in the thermal oxidation zone. The thermal oxidation zone may be configured to be operated at a temperature sufficient to thermally oxidize the liquid PFAS to a fluoride species, and to provide a thermal oxidation effluent.

The apparatus may also include a reaction zone with a vessel containing a solid reactant, the solid reactant configured to receive the thermal oxidation effluent, to neutralize the fluoride species, and to convert any PFAS in the thermal oxidation effluent to a fluorine salt. The apparatus may further include a cooling zone configured to receive the thermal oxidation effluent and to reduce a temperature of the thermal oxidation effluent. The cooling zone may be disposed between the thermal oxidation zone and the reaction zone.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

The FIGURE shows a schematic diagram of an apparatus according to one or more embodiments of the present application.

### DETAILED DESCRIPTION OF THE INVENTION

As mentioned above, the present invention provides for the removal and degradation of PFAS. The PFAS may be oxidized in a thermal oxidizer and any remaining PFAS may then be subjected to degradation in one or more mineralization reactor(s). The mineralization will reduce the chances of release of light fluorinated hydrocarbons or other components from the oxidation of the PFAS. Additionally, the mineralization reactor will neutralize fluoride species produced in the oxidation.

As used herein, “PFAS” means fluorine containing compounds, including, poly- and perflouroalky substances, that include at least one fully fluoridated methyl or methylene carbon atom. Commonly made, used, and found compounds include as perfluorooctanoic acid (PFOA), perfluorooctanesulfonic acid (PFOS), perfluorobutane sulfonic acid (PFBS), perfluoropentanesulfonic acid (PFPS), perfluorohexane sulfonic acid (PFHxS), perfluoroheptanesulfonic acid PFHpS), perfluorononanesulfonic acid (PFNS), or perfluorodecanesulfonic acid (PFDS), hexafluoropropylene oxide dimer acid (HFPO-DA). This list is not intended to be exhaustive, but merely exemplary. Additional PFAS compounds, can be found, for example in the definitions provided by the EPA. Additionally, it should be understood that “PFAS” also refers to the intermediate compounds produced during the conversion of an original PFAS compound. As used herein, the term “stream” can include various hydrocarbon molecules, such as straight-chain, branched, or cyclic alkanes, alkenes, alkadienes, and alkynes, and optionally other substances, such as gases, e.g., hydrogen, or impurities, such as heavy metals, and sulfur and nitrogen compounds. The stream can also include aromatic and nonaromatic hydrocarbons.

As used herein, the term “substantially” can mean an amount generally of at least 90%, preferably 95%, and optimally 99%, by weight, of a compound or class of compounds in a stream.

As depicted, process flow lines in the figures can be referred to interchangeably as, e.g., lines, pipes, feeds, effluents, products, or streams.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

With these general principles in mind, one or more embodiments of the present invention will be described with the understanding that the following description is not intended to be limiting.

Turning to the FIGURE, an apparatus 10 for converting poly- and perfluoroalkyl substances (PFAS). The apparatus 10 receives a feed stream 12 that contains PFAS. In various embodiments, the feed stream 12 is a liquid feed stream that includes PFAS in liquid form, either in liquid phase or as dissolved solid phase PFAS. It is contemplated that the feed stream 12 comprises about 0.01 wt % PFAS, or comprises about 10 wt % PFAS. However, these amounts are merely exemplary and not intended to be limiting. Further, by “about” it is meant to include +/−10% of the stated amount.

The feed stream 12 is passed to an oxidation zone 14 containing at least one reactor vessel 16. In the oxidation zone 14, the PFAS will be oxidized into, among other components, one or more fluoride species, such as anionic fluoride species. In a preferred embodiment, the oxidation zone 14 comprises a thermal oxidation zone 18 in which at least a portion of the reactor vessel 16 comprises a thermal oxidizer 20. Accordingly, an oxidation effluent may also comprise combustion products.

As is known, the thermal oxidizer 20 includes one or more burners 22 that receive a fuel gas stream 24 and a combustion air stream 26 which react in the thermal oxidation zone 18 to produce a flame. Contemplated temperatures for the thermal oxidation zone 18 are sufficient to oxidize the PFAS and may be between about 500° C. to about 2,300 C. Additionally, contemplated residence time may be less than about 30 seconds, or less than about 15 seconds, or less than about 10 seconds, or between about 0.5 to about 3 seconds. Again, these are merely contemplated or exemplary values and are not intended to be limiting.

The feed stream 12 may be injected into the thermal oxidation zone 18. One or more injection nozzles 28 may be provided within the reactor vessel 16 to inject the feed stream 12 into the thermal oxidation zone 18. Prior to passing into the reactor vessel 16, the feed stream 12 may be atomized. For example, the feed stream 12 may be atomized with an atomization fluid 30, for example air, and then the atomization fluid and liquid PFAS (that is atomized) may be injected into the thermal oxidation zone 18. Alternatively, the feed stream 12 may be atomized with a mechanical atomizer, and thus, no separate atomization fluid 30 may be needed to atomize the feed stream 12.

According to the present processes at least 90 wt %, or between 90 to 99.999 wt %, or between 90 to 99.9999 wt % of the PFAS from the feed stream 12 is converted to the fluoride species in the oxidation zone 14. In some embodiments, 100 wt % of the PFAS is converted to the fluoride species in the oxidation zone 14.

In order to increase the degradation of PFAS and to reduce the reactivity of the fluoride species, the oxidation zone effluent 32 is passed to a reaction zone 40. However, prior to the reaction zone 40, the oxidation zone effluent 32 may be cooled in a thermal reduction zone 34, or cooling zone, so that a temperature of the oxidation zone effluent 32 is reduced, preferably by at least 5%.

The thermal reduction zone 34 may include a heat exchange zone with a heat exchanger configured to transfer heat from the oxidation zone effluent 32 to a heat exchange fluid. The heat exchanger could be located within the reactor vessel 16 or it could be located externally.

Additionally, or alternatively, the thermal reduction zone 34 may include a quench zone 36 that may be a portion of the reactor vessel 16 in the oxidation zone 14. The quench zone 36 receives a quench fluid 38 may be injected into the quench zone. The quench fluid 38 may be water, air, or a combination thereof.

In some embodiments, a sensor (not shown) or other monitoring device may be used to measure a temperature of the oxidation zone effluent 32 at various points (i.e., upstream of the thermal reduction zone 34 and/or downstream of the thermal reduction zone 34). The obtained or measured temperature may be compared to a predetermined temperature or other set point a flow of a cooling fluid (i.e., a heat exchange fluid and/or quench fluid 38) may be adjusted in response to the comparison to raise or lower the temperature of the oxidation zone effluent 32.

With or without thermal reduction, the oxidation zone effluent 32 is passed to the reaction zone 40 to reduce the reactivity of the fluoride species and to increase the degradation of PFAS. While the oxidizing may be performed at a first temperature, and the neutralizing and the converting may be performed at a second temperature that is less than the first temperature by at least 5%.

The reaction zone 40 may contain one or more mineralization reactors 42. If more than one mineralization reactors 42 is utilized, the reactors 42 may be arranged in series, or parallel, or in other arrangements.

Each mineralization reactor 42 is configured to be operated at a temperature between ambient temperature to about 1,000° C. Moreover, it is contemplated that different reactors 42 have different operating temperatures. For example, a first mineralization reactor 42 may have an operating temperature between about 300° C. to about 1,000° C., while a second mineralization reactor 42, which receives an effluent from the first mineralization reactor, may have an operating temperature between about ambient temperature to about 1,000° C.

Mineralization will minimize emission of light fluorinated hydrocarbons (which have extremely high global warming potentials compared to carbon dioxide). The mineralization reactor 42 contains a solid reactant which is configured to neutralize the fluoride species and to convert any PFAS in the oxidation effluent to a fluorine salt (as well as carbon dioxide, water, and other compounds). The solid reactant may be a base of calcium, sodium, potassium, lithium, magnesium, aluminum, silicon, and combinations thereof. By “base” it is meant to include oxides, hydroxides, carbonates, phosphates, and silicates. Thus, the solid reactant may be a salt of calcium, sodium, potassium, lithium, magnesium, or a combination thereof, or may be aluminum oxide, or both. For example, the solid reactant may be calcium hydroxide, calcium oxide, calcium carbonate, or combinations thereof.

The oxidation zone effluent 32 may have a residence time in the mineralization reactor 42 and/or in the presence of the solid reactant for a time between 0.5 seconds to 10 minutes.

An effluent stream 44 from the reaction zone 40 may be treated in a treatment zone (not shown), which many include a wet scrubber, a dry scrubber, a guard bed, a catalytic reaction zone, or any combination thereof, before being released to the atmosphere.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be used to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps.

For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

### Experiments

### Thermal Oxidation

The modeling of the thermal oxidation zone begins with known properties of the fuel, atmospheric air, and waste (PFAS+others if applicable). Utilizing industry known values including but not limited to latent heat of evaporation, heat capacity, adiabatic flame temperature, and chemical composition of these streams (where applicable), the model can begin to calculate the estimated flame temperature within the oxidation zone. Afterwards, a target excess oxygen value is used to model the bulk oxidation zone operating temperature. Since the oxidation zone vessel size and shape can be freely adjusted by the designer, a calculation can be made to determine the oxidation zone bulk residence time based on this specified geometry, vapor flow rates, and temperatures. Years of operating data (temperature profiles, fuel flow rates, stack emissions samples, etc.) collected from units designed to oxidize halogen containing organic wastes, combined with the calculations data described previously, a sufficient oxidation zone model can be created to target the oxidation and removal efficiency desired.

In the modeling of the thermal oxidation zone, a PFAS containing wastewater stream composing of 0.5% by weight of PFAS and 99.5% by weight of water was oxidized in a thermal oxidation modeling program at 1,343.3° C. and at a minimum residence time of 2 seconds. Pure methane was used as the fuel source for the oxidation and ambient air used as the oxygen source. The theoretical model results showed a PFAS waste conversion to HF of upwards of 99.9999%.

### HF Neutralization

HF neutralization via mineralization with Ca based adsorbents was modeled utilizing a shrinking core model. This model is used to help determine quantity of mineralization reactors need as well as the reactor mineralization reactor or reactors sizing. The shrinking core model is influenced by several material parameters such as particle porosity, pore size, particle diameter, and diffusivity of HF as well as the reactor conditions (temperature, HF concentration). Additionally, the equilibrium concentration of HF under mineralization reactor conditions in the presence of other molecules (water, CO₂) is key to determining the potential need for multiple reactors in series.

The effluent from the modeled thermal oxidizer, containing both HF and PFAS materials, was simulated in Unisim and cooled from thermal oxidizer effluent temperature to 550° C. utilizing a quench fluid (either air or water). This cooled stream provided inlet conditions to the mineralization/neutralization reactor model, including the flow rate, temperature, and pressure as well as the concentration of HF, CO₂, and water. Reactor inlet conditions for the air and water quench cases are outlined in Table 1 below:

TABLE 1

| Parameter | Units | Air Quench | Water Quench |
|---|---|---|---|
| Molar Flow | MMSCFD | 1.46 | 0.86 |
| Temperature | ° C. | 550 | 550 |
| Pressure | bar(a) | 1.05 | 1.05 |
| HF Concentration | ppm | 90 | 171 |
| CO₂ Concentration | mol % | 2.7% | 5.0% |
| Water Concentration | mol % | 9.8% | 44.3% |

These reactor inlet conditions were input into the shrinking core neutralization model along with effective diffusivity (48 cm²/min) and particle diameter estimates (0.21 cm). The output of the model predicted a mineralization zone length. This, combined with the number of hours of operation and pressure drop requirement was used to size the diameter and tangent length of the reactor. The equilibrium HF slip was also calculated based on the reactor conditions shown in Table 2, below

TABLE 2

| Parameter | Units | Air Quench | Water Quench |
|---|---|---|---|
| Mineralization Zone | cm | 0.22 | 0.17 |
| Length | | | |
| % Solid Converted at | % | 99.9% | 99.9% |
| Breakthrough | | | |
| Pressure Drop | bar | 0.079 | 0.066 |
| Rx Diameter | cm | 159 | 142 |
| Rx Bed Length | cm | 75 | 105 |
| Equilibrium HF Slip | ppm | 3 | 9 |

For the air quench and water quench cases above, equilibrium HF slip are 3 ppm and 9 ppm, respectively. Following the primary mineralization reactor with an additional cooling step and polishing mineralization reactor reduces equilibrium HF slip to meet environmental regulations. For example, cooling to 300° C. with air and water quench give HF slip of 0.1 ppm and 0.3 ppm, respectively.

### PFAS and Calcium Base

PFOA (0.15 g) was dissolved in water (15 g), and a UOP zeolite (0.98 g) was added. The zeolite was prepared according to the methods set forth in U.S. Ser. No. 10/632,454. The mixture was stirred for 1 day at room temperature. The solid was separated from the liquid through centrifugation. The zeolite was combined with water and centrifuged to rinse any non-adsorbed PFAS away. The PFOA loaded zeolite was dried at 80° C. on a rotovap rotary evaporator. The PFOA loaded zeolite (1.0 g) was combined with calcium oxide (1.42 g) and ground with a mortar and pestle. The solid mixture was then slowly poured into a glass reactor and. heated in a furnace at 525° C. for 20 min. After cooling, the solid was analyzed by XRD. XRD indicated the formation of calcium fluoride. It is believed that similar results will be shown when the PFAS are introduced to the calcium base.

### Specific Embodiments

While the following is described in conjunction with specific embodiments, it will be understood that this description is intended to illustrate and not limit the scope of the preceding description and the appended claims.

A first embodiment of the invention is a process for converting poly- and perfluoroalkyl substances (PFAS), the process comprising injecting a feed comprising liquid PFAS into a thermal oxidation zone; and, thermally oxidizing, in the thermal oxidation zone, the PFAS to provide a thermal oxidation effluent comprising a fluoride species. An embodiment of the invention is one, any or all of prior embodiments in this paragraph up through the first embodiment in this paragraph, wherein the liquid PFAS is injected into a thermal oxidizer in the thermal oxidation zone with one or more injection nozzles. An embodiment of the invention is one, any or all of prior embodiments in this paragraph up through the first embodiment in this paragraph, further comprising atomizing the liquid PFAS before the feed is injected into a thermal oxidizer in the thermal oxidation zone with one or more injection nozzles. An embodiment of the invention is one, any or all of prior embodiments in this paragraph up through the first embodiment in this paragraph, wherein the thermal oxidation zone is configured to oxidize between 90 to 99.9999% of the PFAS in the feed. An embodiment of the invention is one, any or all of prior embodiments in this paragraph up through the first embodiment in this paragraph, wherein the thermally oxidizing is performed at a temperature between about 500° C. to about 2,300° C. An embodiment of the invention is one, any or all of prior embodiments in this paragraph up through the first embodiment in this paragraph further comprising cooling, in a cooling zone, the thermal oxidation effluent. An embodiment of the invention is one, any or all of prior embodiments in this paragraph up through the first embodiment in this paragraph, further comprising neutralizing, in a reaction zone comprising a vessel with a solid reactant, the fluoride species with the solid reactant; and, converting, with the solid reactant in the reaction zone, any PFAS in the thermal oxidation effluent to a fluorine salt. An embodiment of the invention is one, any or all of prior embodiments in this paragraph up through the first embodiment in this paragraph, wherein the solid reactant is selected from a group consisting of a base of calcium, sodium, potassium, lithium, magnesium, aluminum, silicon, and combinations thereof. An embodiment of the invention is one, any or all of prior embodiments in this paragraph up through the first embodiment in this paragraph, wherein the thermally oxidizing is performed at a first temperature, and wherein the neutralizing and the converting are performed at a second temperature less than the first temperature by at least 5%.

A second embodiment of the invention is a process for converting poly- and perfluoroalkyl substances (PFAS), the process comprising passing a feed comprising liquid PFAS into a thermal oxidation zone by injecting the liquid PFAS towards a flame in the thermal oxidation zone, the thermal oxidation zone comprising a vessel; and, thermally oxidizing the PFAS to a fluoride species and producing a thermal oxidation effluent. An embodiment of the invention is one, any or all of prior embodiments in this paragraph up through the second embodiment in this paragraph, wherein the liquid PFAS is injected via one or more injection nozzles in the thermal oxidation zone. An embodiment of the invention is one, any or all of prior embodiments in this paragraph up through the second embodiment in this paragraph, wherein the one or more injection nozzles are configured to receive a liquid stream comprising the liquid PFAS. An embodiment of the invention is one, any or all of prior embodiments in this paragraph up through the second embodiment in this paragraph, wherein the one or more injection nozzles are configured to receive an atomized stream comprising the liquid PFAS. An embodiment of the invention is one, any or all of prior embodiments in this paragraph up through the second embodiment in this paragraph, wherein the thermally oxidizing is performed at a temperature between about 500° C. to about 2,300° C. An embodiment of the invention is one, any or all of prior embodiments in this paragraph up through the second embodiment in this paragraph, further comprising passing the thermal oxidation effluent to a reaction zone comprising a vessel with a solid reactant, the solid reactant configured to neutralize the fluoride species and to convert any PFAS in the thermal oxidation effluent to a fluorine salt. An embodiment of the invention is one, any or all of prior embodiments in this paragraph up through the second embodiment in this paragraph, further comprising cooling, in a cooling zone, the thermal oxidation effluent before passing the thermal oxidation effluent to the reaction zone. An embodiment of the invention is one, any or all of prior embodiments in this paragraph up through the second embodiment in this paragraph, wherein the cooling zone comprises a quench zone in the vessel in the thermal oxidation zone.

A third embodiment of the invention is an apparatus for converting poly- and perfluoroalkyl substances (PFAS), the apparatus comprising a thermal oxidation zone comprising a vessel with one or more injected nozzles, the one or more injection nozzles configured to receive a feed comprising liquid PFAS and inject the liquid PFAS toward a flame in the thermal oxidation zone, wherein the thermal oxidation zone is configured to be operated at a temperature sufficient to thermally oxidize the liquid PFAS to a fluoride species, and to provide a thermal oxidation effluent. An embodiment of the invention is one, any or all of prior embodiments in this paragraph up through the third embodiment in this paragraph, further comprising a reaction zone comprising a vessel with a solid reactant, the solid reactant configured to receive the thermal oxidation effluent, to neutralize the fluoride species, and to convert any PFAS in the thermal oxidation effluent to a fluorine salt. An embodiment of the invention is one, any or all of prior embodiments in this paragraph up through the third embodiment in this paragraph, further comprising a cooling zone configured to receive the thermal oxidation effluent and to reduce a temperature of the thermal oxidation effluent, wherein the cooling zone is disposed between the thermal oxidation zone and the reaction zone. Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims. In the foregoing, all temperatures are set forth in degrees Celsius and, all parts and percentages are by weight, unless otherwise indicated.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understanding the embodiments of the present invention.

What is claimed is:

1. A process for converting poly- and perfluoroalkyl substances (PFAS), the process comprising:
injecting a feed comprising liquid PFAS into a thermal oxidation zone; and,
thermally oxidizing, in the thermal oxidation zone, the PFAS to provide a thermal oxidation effluent comprising a fluoride species.

2. The process of claim 1, wherein the liquid PFAS is injected into a thermal oxidizer in the thermal oxidation zone with one or more injection nozzles.

3. The process of claim 1, further comprising:
atomizing the liquid PFAS before the feed is injected into a thermal oxidizer in the thermal oxidation zone with one or more injection nozzles.

4. The process of claim 1, wherein the thermal oxidation zone is configured to oxidize between 90 to 99.9999% of the PFAS in the feed.

5. The process of claim 1, wherein the thermally oxidizing is performed at a temperature between about 500° C. to about 2,300° C.

6. The process of claim 1 further comprising:
cooling, in a cooling zone, the thermal oxidation effluent.

7. The process of claim 1, further comprising:
neutralizing, in a reaction zone comprising a vessel with a solid reactant, the fluoride species with the solid reactant; and,
converting, with the solid reactant in the reaction zone, any PFAS in the thermal oxidation effluent to a fluorine salt.

8. The process of claim 7, wherein the solid reactant is selected from a group consisting of: a base of calcium, sodium, potassium, lithium, magnesium, aluminum, silicon, and combinations thereof.

9. The process of claim 7, wherein the thermally oxidizing is performed at a first temperature, and wherein the neutralizing and the converting are performed at a second temperature less than the first temperature by at least 5%.

10. A process for converting poly- and perfluoroalkyl substances (PFAS), the process comprising:
passing a feed comprising liquid PFAS into a thermal oxidation zone by injecting the liquid PFAS towards a flame in the thermal oxidation zone, the thermal oxidation zone comprising a vessel; and,
thermally oxidizing the PFAS to a fluoride species and producing a thermal oxidation effluent.

11. The process of claim 10, wherein the liquid PFAS is injected via one or more injection nozzles in the thermal oxidation zone.

12. The process of claim 11, wherein the one or more injection nozzles are configured to receive a liquid stream comprising the liquid PFAS.

13. The process of claim 11, wherein the one or more injection nozzles are configured to receive an atomized stream comprising the liquid PFAS.

14. The process of claim 10, wherein the thermally oxidizing is performed at a temperature between about 500° C. to about 2,300° C.

15. The process of claim 10, further comprising:
passing the thermal oxidation effluent to a reaction zone comprising a vessel with a solid reactant, the solid reactant configured to neutralize the fluoride species and to convert any PFAS in the thermal oxidation effluent to a fluorine salt.

16. The process of claim 15, further comprising
cooling, in a cooling zone, the thermal oxidation effluent before passing the thermal oxidation effluent to the reaction zone.

17. The process of claim 16, wherein the cooling zone comprises a quench zone in the vessel in the thermal oxidation zone.

18. An apparatus for converting poly- and perfluoroalkyl substances (PFAS), the apparatus comprising:
a thermal oxidation zone comprising a vessel with one or more injected nozzles, the one or more injection nozzles configured to receive a feed comprising liquid PFAS and inject the liquid PFAS toward a flame in the thermal oxidation zone,
wherein the thermal oxidation zone is configured to be operated at a temperature sufficient to thermally oxidize the liquid PFAS to a fluoride species, and to provide a thermal oxidation effluent.

19. The apparatus of claim 18, further comprising:
a reaction zone comprising a vessel with a solid reactant, the solid reactant configured to receive the thermal oxidation effluent, to neutralize the fluoride species, and to convert any PFAS in the thermal oxidation effluent to a fluorine salt.

20. The apparatus of claim 19, further comprising:
a cooling zone configured to receive the thermal oxidation effluent and to reduce a temperature of the thermal oxidation effluent,
wherein the cooling zone is disposed between the thermal oxidation zone and the reaction zone.
